(19) United States
(12) Patent Application Publication
(10) Pub. No.: US 2017/0302735 A1
(43) Pub. Date: Oct. 19, 2017

(54) METHOD AND SYSTEM FOR INTEGRATING MULTIPLE MULTI-MEDIA COMPUTER APPLICATIONS INTO A SINGLE MULTI-MEDIA COMPUTER APPLICATION READER

(71) Applicant: J. Michael Miller, Livermore, CA (US)

(72) Inventor: J. Michael Miller, Livermore, CA (US)

(21) Appl. No.: 15/412,752

(22) Filed: Jan. 23, 2017

Related U.S. Application Data
(63) Continuation-in-part of application No. 14/559,820, filed on Dec. 3, 2014, now abandoned.
(60) Provisional application No. 61/911,436, filed on Dec. 3, 2013.

(51) Int. Cl. H04L 29/08

(52) U.S. Cl. CPC H04L 67/1095; H04L 67/34; H04L 67/06; H04L 67/1097

(57) ABSTRACT

A communications system comprising a computer device connected to a communications network. The computer device having one or more computer-based multimedia applications downloaded from the communications network. The computer-based multimedia applications being connected to respective servers through the communications system and the computer device. The computer device also having a computer-based multimedia application reader downloaded from the communications network that communicates with one or more of the computer-based multimedia applications. The computer-based multimedia application reader capable of copying all multimedia files stored in the computer device and/or the computer-based multimedia applications.

The computer-based multimedia application reader is also connected to a respective server through the communications network and/or computer device, which is capable of storing all multimedia files copied by said computer-based multimedia application reader.

### CROSS REFERENCE TO RELATED APPLICATIONS

This application is a continuation-in-part of U.S. patent application Ser. No. 14/559,820, filed on Dec. 3, 2014, which claims the benefit of U.S. Provisional Application No. 61/911,436, filed on Dec. 3, 2013, the disclosures of which are hereby incorporated by reference thereto.

### TECHNICAL FIELD

The invention relates to a computer method and system for integrating multiple multi-media computer applications into a single multi-media application, and more particularly, to a method and system for reading multi-media files in multiple computer applications in a single computer application.

### STATEMENT REGARDING FEDERALLY SPONSORED RESEARCH OR DEVELOPMENT

(Not applicable)

### BACKGROUND OF THE INVENTION

Over the past decade, people have turned more and more to the Internet to purchase items. This is overwhelmingly the scenario when it comes to the purchase of music, movies, books and other multi-media entertainment. Today's computer users download many multi-media files through various computer-based multimedia applications such as iTunes®, Barnes & Noble's Nook®, Amazon's Kindle®, etc. Most computer device users use more than one multi-media computer-based application to download their multi-media files, requiring the user to keep multiple computer-based applications on their computer device and access each depending on the type of multimedia the user wishes to access.

Additionally, when a user downloads multiple multi-media files through the various multi-media computer-based applications, the user is required to use the computer based application from which the file was downloaded to view or listen to the file or go through a complicated series of steps to move the files into a cloud and then access the cloud from another device or application. For instance, when a user downloads a movie from iTunes®, the user cannot open the movie in another computer-based multi-media application such as the Kindle® unless they first upload the movie into cloud and then transfer the file to their Kindle. This claim of information has extended into search engines and phones where every device one uses has its own claim to the information it collects on the device the user has selected whether it is a tablet, phone or other multi-media application.

Another aspect of present day multi-media computer-based applications is that the multimedia files once downloaded are stored on the user's hard drive. This allows the user to access the file, i.e. a music file purchased from an application such as iTunes or Amazon and reformat the file to one that is easily transferable via email to other users via email without the need to purchase the music thus adding to the $3 billion dollar plus piracy loss in the music industry alone per year. Therefore, the user can download a song file and then remove any digital protections on the file and then share the file with others freely. Thus, resulting in a loss of profit for the record label, production company, and primarily the creative soul of the music that crafted the work from the beginning, the artist. The file will be available for free to people who normally have had to purchase the file in order to listen to it, as mentioned, creating a $3 Billion Dollar a year piracy loss in the music industry alone.

Yet another downfall in the evolution of current computer-based multimedia applications is the inability to segregate and organize multiple multimedia files that have been combined within multi-media applications that beg the need for organization if the source existed for such segregation and organization;, for example pictures contained within an multi-media eBook; videos contained with multi-media eBooks; music contained within multi-media eBooks, or accompanying notes, combined with the above combination of multi-media sources used with multi-media eBooks; multi-media applications combining text, music, images, photos, videos, etc. presently would remain solely within the one multimedia application when music may be segregated into playlists and videos organized with other applications of similar design. Videos may be segregated and organized by use if workout videos from various eBooks were segregated and organized into the invention by category providing for organizational ease by the user having workout videos viewable by category in the invention without the need to open each individual eBook to review the workout video. The same would be true of cookbook recipe's or music applications organized by artist and playlists with lyrics organized by artist in text category of the invention gathered from the application of the user.

Therefore, a need exists for a single computer-based application that can read a variety of multi-media files that have been downloaded from other applications and sync all of those multi-media files in one place, while maintaining the integrity and security of the files as defined above with the additional encryption methods In addition, once this synchronization of applications has taken place within the inventions, the user is free to remove the application file from its computer freeing up storage on its device as the information is now stored on the Invention's communications network server(s).

### SUMMARY OF THE INVENTION

A communications system comprising a computer device connected to a communications network. The computer device having one or more computer-based multimedia applications downloaded from the communications network. The computer-based multimedia applications being connected to respective servers through the communications system and the computer device. The computer device also having a computer-based multimedia application reader downloaded from the communications network that communicates with one or more of the computer-based multimedia applications. The computer-based multimedia application reader capable of copying all multimedia files stored in the computer device and/or the computer-based multimedia applications. The computer-based multimedia application reader is also connected to a respective server through the communications network and/or computer device, which is capable of storing all multimedia files copied by said computer-based multimedia application reader.

### BRIEF DESCRIPTION THE DRAWINGS

The operation of the invention will become apparent from the following description taken in conjunction with the drawings, in which:

FIG. 1a is a flowchart illustrating a general overview of the inventive system;

FIG. 1b is a flowchart of the method used by the inventive system;

FIG. 2 is a flowchart of yet another inventive method used by the inventive system in which the inventive system searches computer-based multimedia applications;

FIG. 3 is a flowchart of yet another inventive method used by the inventive system in which the inventive system searches for multimedia files based on account information;

FIG. 4 is a flowchart of the inventive system in which the system copies all aspects of a single multimedia file and separates all individual files according to format;

FIG. 5 is a flowchart of the inventive system in which the system stores notes made by a user;

FIG. 6 illustrates a possible graphical user interface for use with the inventive system and method;

FIG. 7 illustrates a possible graphical user interface for use with the inventive system and method;

FIG. 8 illustrates a possible graphical user interface for use with the inventive system and method;

FIG. 9 illustrates a possible graphical user interface for use with the inventive system and method;

FIG. 10 illustrates a possible graphical user interface for use with the inventive system and method;

FIG. 11 illustrates a possible graphical user interface for use with the inventive system and method;

FIG. 12 illustrates a possible graphical user interface for use with the inventive system and method.

FIG. 13 illustrates a possible graphical user interface for use with the inventive system and method;

FIG. 14 illustrates a possible graphical user interface for use with the inventive system and method;

FIG. 15 illustrates a possible graphical user interface for use with the inventive system and method;

FIG. 16 illustrates a possible graphical user interface for use with the inventive system and method;

FIG. 17 illustrates a possible graphical user interface for use with the inventive system and method;

FIG. 18 illustrates a possible graphical user interface for use with the inventive system and method;

FIG. 19 illustrates a possible graphical user interface for use with the inventive system and method;

FIG. 20 illustrates a possible graphical user interface for use with the inventive system and method;

FIG. 21 illustrates a possible graphical user interface for use with the inventive system and method;

FIG. 22 illustrates a possible graphical user interface for use with the inventive system and method;

FIG. 23 illustrates a possible graphical user interface for use with the inventive system and method;

### DETAILED DESCRIPTION OF THE PREFERRED EMBODIMENTS

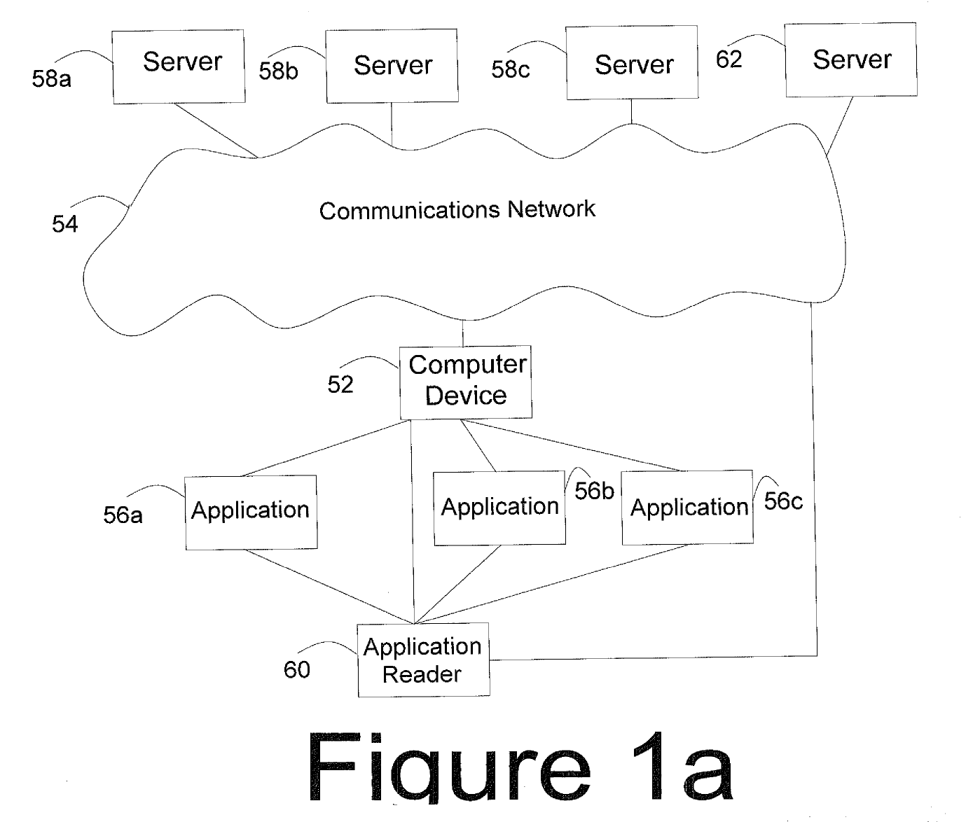

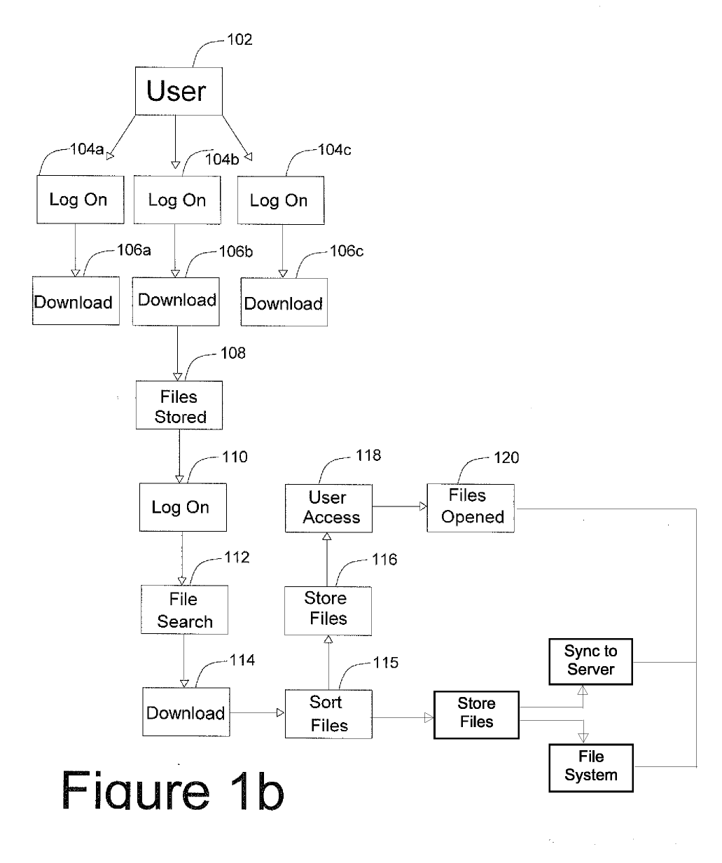

Referring to FIG. 1a, an overview of the inventive system 50 may be understood. A user with computer device 52 would connect to a communications system 54, such as the Internet and download computer-based multimedia applications 56a-56c. Computer-based multimedia applications 56a-56c may be of any multimedia type, such as movies, electronic books, music, images, etc. For example, computer-based multimedia applications 56 may include, but are not limited to, ‘Meeggo’, ‘Dig Myself a hole 'n bury myself in it’, etc. The user is also not limited in the types of computer-based multimedia applications he/she may download over communications system 54. The user may download as many computer-based multimedia applications as his/her computer device 52 will allow. Computer-based multimedia applications 56a-56c communicate through computer device 52 over communications network 54 to servers 58a-58c, respectively; that is computer-based multimedia application 56a communicates through computer device 52 over communications network 54 to server 58a. For example, a user's Meeggo application communicates to the MuZook server through the user's device over the Internet. The user also downloads the inventive application reader 60, which communicated with computer device 52, computer-based multimedia applications 56, communications network 54, and its own server 60. In this way, application reader 60 is resident on computer device 52 and able to communicate directly with computer-based multimedia applications 56.

Referring to FIG. 1b, an overview of the inventive method may be understood. A user 102 logs into computer-based applications at step 104a-104c and downloads various multimedia files at step 106a-106c. User 102 may log into a single computer-based application 104a or many computer based applications 104a-104c. FIG. 1b illustrates three computer based applications, but the inventive system is not restricted to just three computer-based applications. It is very possible for user 102 to log-in to as many computer-based applications that the user's device will allow. Computer-based applications may be any computer-based multimedia application, for example, ‘Meeggo’, ‘Dig Myself a hole 'n bury myself in it’, etc. Multimedia files can be of any multimedia format, including but not limited to .mov, .mp4, .m4v, .mp3, .wav, .mpeg, .jpg, .png, .aef, .epub, .lrf, .lrx, .cbr, .cbz, .cb7, .cbt, .cba, .chm, DAISY, .html, .djvu, .azw, .lit, .exe, etc. Once user 102 has downloaded multimedia files at step 106 through a computer-based application, the multimedia files are stored at step 108 in user 102's computer device. The computer device may be any computer device including but not limited to a personal computer, a laptop computer, a tablet, a smartphone, etc. At step 110, user 102 logs into the inventive computer based application. The inventive computer-based application then searches for all multimedia files stored on the user's device at step 112 and downloads those multimedia files at step 114 and stores the multimedia files at step 116. The inventive application reader stores the multimedia files according to category of file type at step 115. For example, all video files are stored in one place, for example, a folder, within the application reader, while electronic book files are stored in another, and movie files in yet another, etc. User 102 is now able to access all of his/her multimedia files through the inventive application reader at step 118 by selecting a folder/category of multimedia, and listen, watch, or read, his/her multimedia files of that type through the inventive application reader at step 120.

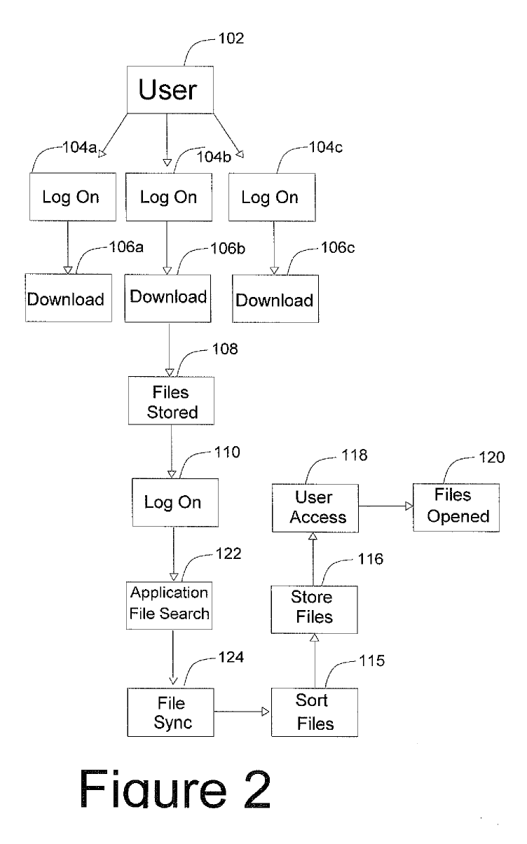

Another embodiment of the inventive system is illustrated in FIG. 2. In this embodiment, User 102 proceeds through steps 104-110 as described above. Here, the inventive computer-based application reader searches all the multimedia computer-based applications that are on the user's computer device at step 122. This is on contrast to searching for the files in the user's device's memory itself. In this embodiment, the inventive computer-based application reader is able to connect directly to computer-based multimedia applications such as Meeggo or connected to the computer-based multimedia application's service, for example, MuZook, and search for the multimedia files associated with each computer-based multimedia application, essentially reading all the device's computer-based multimedia applications. The inventive application reader then syncs all the multimedia files from the computer-based applications by downloading the multimedia files at step 124. The inventive application reader then stores the multimedia files as described above in step 116 and user 102 may access and use the multimedia files as described in steps 118 and 120 above.

The inventive application reader stores all the multimedia files as described above in step 116 on its own servers. Multimedia files may be stored locally under operating system encryption and an addition a per-file encryption. When a user logs into the inventive application reader, the multimedia file are accessed from the applications servers or via doubly encrypted local files. Thus, once the multimedia files are downloaded and stored on the inventive application reader's servers, they are additionally protected from piracy by others and by the user since the underlying file is either not stored on the hard drive or if it is locally stored, it has multiple layers of encryption for additional security. In order to gain access to the multimedia file through the inventive application a user would have to hack into the servers or hack through multiple layers of encryption. Therefore, the inventive system provides an extra layer of security and integrity to the underlying multimedia files.

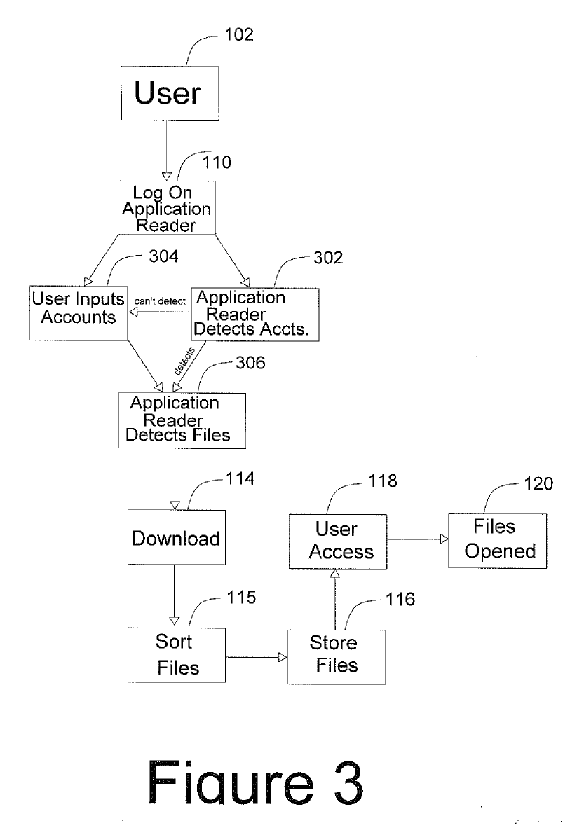

Furthermore, the inventive application reader may read all multimedia filed associated with a user's computer-based application account name as illustrated in FIG. 3. User 102 logs into the inventive application reader at step 110 as described above. The inventive application reader then detects all of the users account information, including username and password, from all computer-based multimedia applications at step 302. Alternatively, user 102 may input all of his account information, including username and password, into the inventive applications reader at step 304. If the inventive application reader cannot detect any account information, the reader will go to step 304 and ask the user to input the account information. Once the account information has been obtained the system moves to step 306 and searches for all multimedia files associated with the accounts. The system then proceeds through steps 114-120 as described above.

Yet another feature of the inventive application reader is the ability to separate out individual multimedia files that have been combined and store them. For instance, the inventive application reader can take an image file from an electronic book and separate that image file from the book file and store the image file in a separate image library.

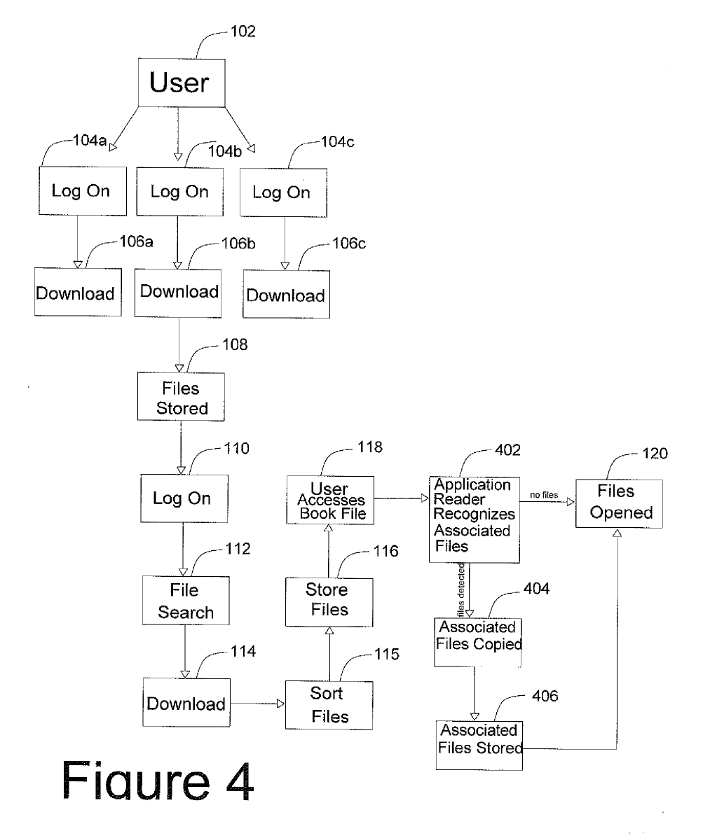

Referring to FIG. 4, User 102 follows steps 104-116 as described above At step 118, User 102 then opens an electronic book from within the application reader. The application reader then searches all the multimedia files contained within the electronic book at step 402. The multimedia files may include, but are not limited to, text, notes, images in the book, music that is to be played along with the book, sound clips, movie clips, etc. The application reader then proceeds to copy the various multimedia files associated with the book at step 404. Then, depending on the type of multimedia file, the file is stored within a specific area of the application reader that stores all files of that category at step 406. Once the multimedia files have been downloaded, separated, and stored, user 102 proceeds to step 120 as above to read the book or view the other multimedia files. If the electronic book does not have any other multimedia files associated with it, then the system will proceed from step 402 to step 120.

In the embodiment illustrated in FIG. 4, the inventive application reader does not disrupt the original electronic book file. The application reader merely copies the associated multimedia files, separates them into categories based on their format type, and stores them within a specific area of the application reader that stores all files of the same category. Thus, a user may use the inventive application reader to read the electronic book with all the associated multimedia content as originally downloaded or the user may choose to view specific multimedia files that have been separated from the original. For instance, a user may just want to listen to a music file that came with the electronic book, or a user may want to look at the images that came with the electronic book.

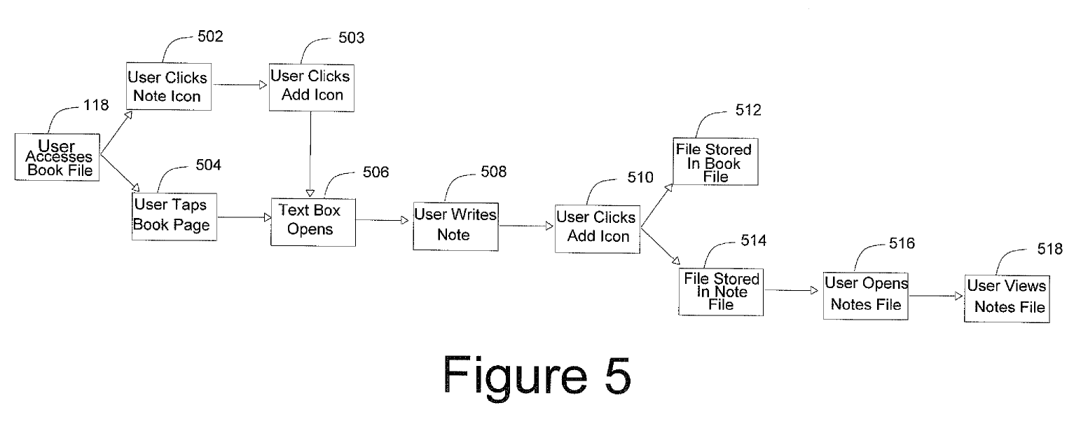

Referring to FIG. 5, yet another feature of the present invention may be understood. The inventive application reader allows a user to take notes within an electronic book inside the application and then stores that note with the electronic book file and separately in a notes category within the application reader. User 102 follows steps 104-116, FIG. 4 above. At step 118, user 102 opens an electronic book multimedia file from within the book category of the application reader. Once the electronic book file is open, user 102 may take notes on any page of the electronic book. User 102 may either click on a note icon at step 502 or simply tap the location on the book page where he/she wishes to write the note and clicks the notes icon, step 504. If the user has already written notes, those previous notes will be available to view at step 502 and 504. If the user clicks on the notes icon, the user will have to further click the add icon at step 503. A text box then opens at step 506 and user 102 writs his/her note at step 508. User 102 then saves his/her note at step 510 by clicking a save button/icon. The inventive application reader then stores the note. The note is stored with the electronic book's multimedia file at step 512, so that a user may open the note whenever he/she is at that particular page in the book or whenever the user opens the electronic book file. The note is also stored simultaneously in the notes category of the application reader separate from the electronic book file at step 514. User 102 may then open the notes folder within the application reader at step 516 and view all the notes he/she has taken in any electronic book at step 518.

The above embodiment also works for highlights and underlines made in any electronic book file, enabling a user to view the highlights and underlines from electronic books in the notes category in the application reader.

The above embodiment illustrated in FIGS. 4 and 5 and described in detail above allow a user to access parts of an electronic book, such as images, and notes, highlights, and underlines made in the electronic book even after the user has deleted the electronic book from the application reader or even deleted the book from the original computer-based multimedia application.

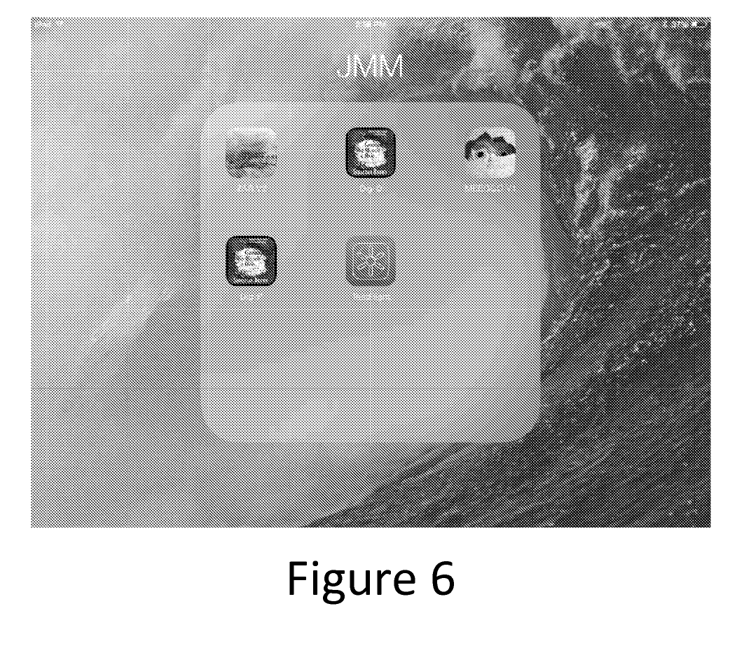

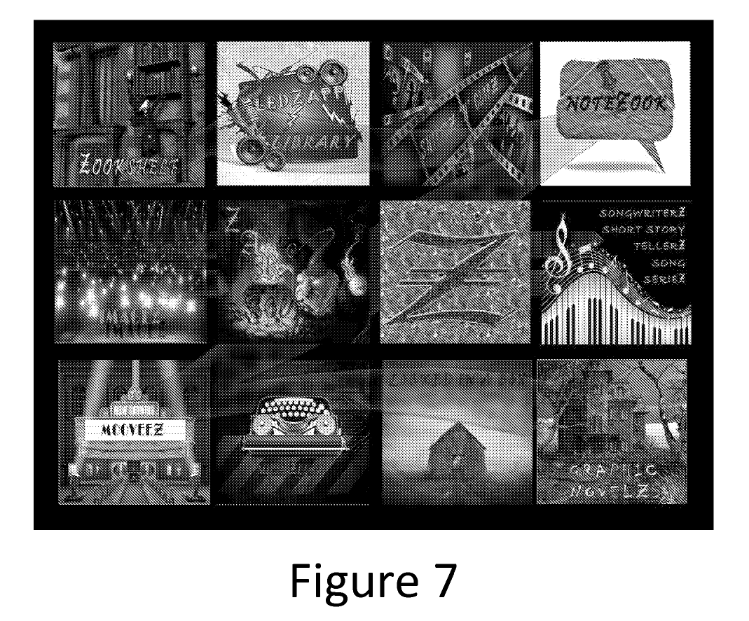

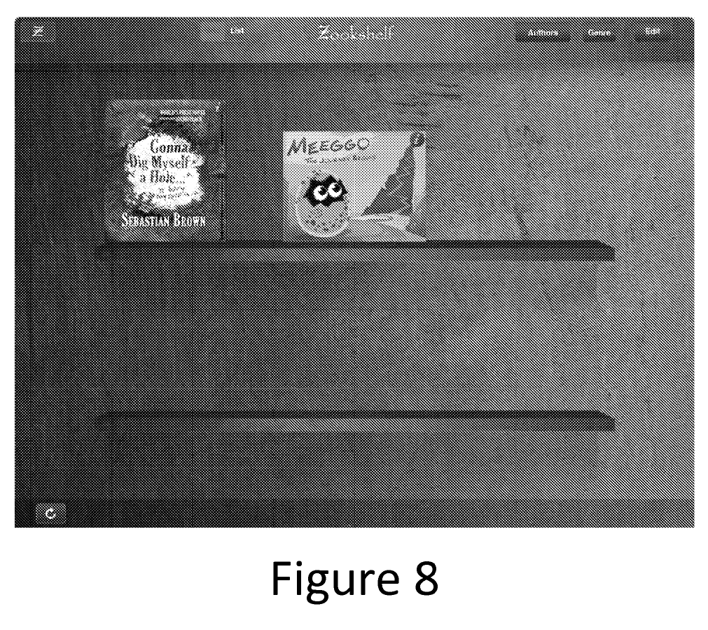

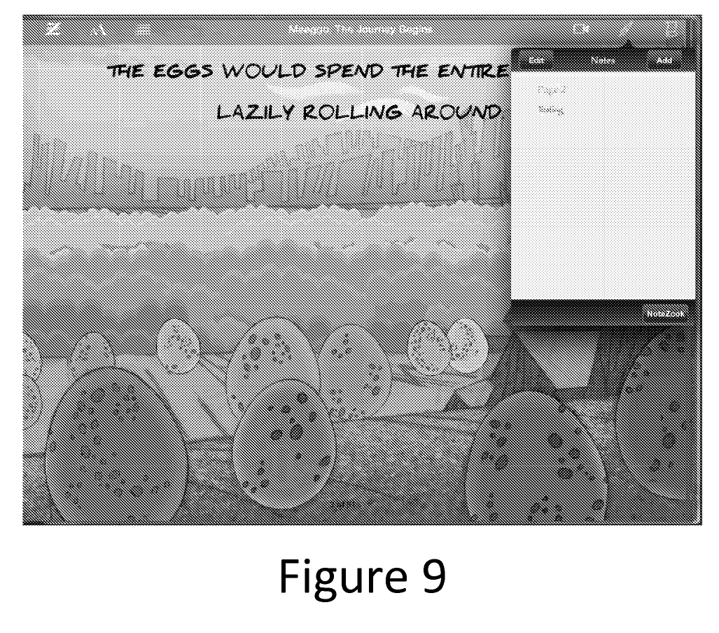

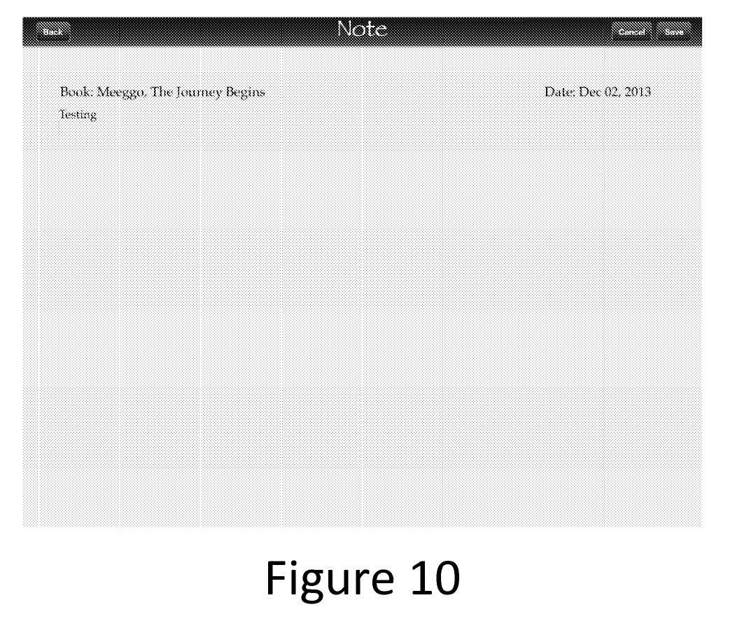

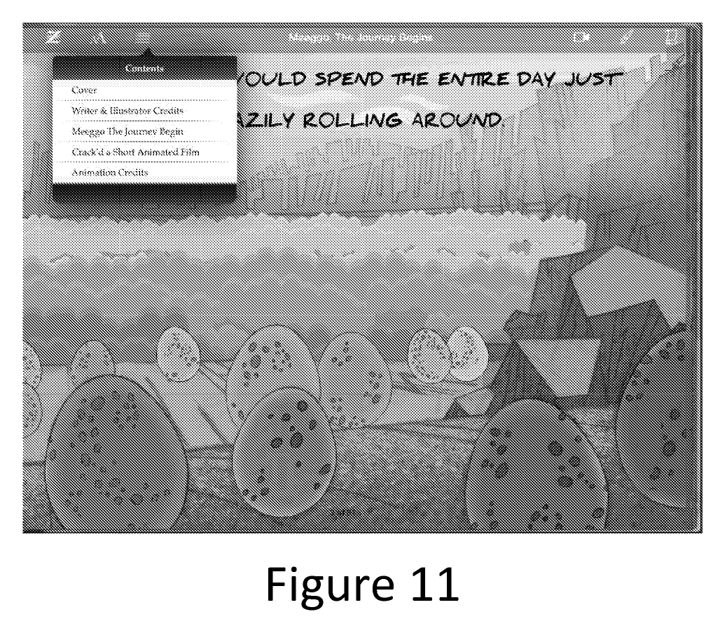

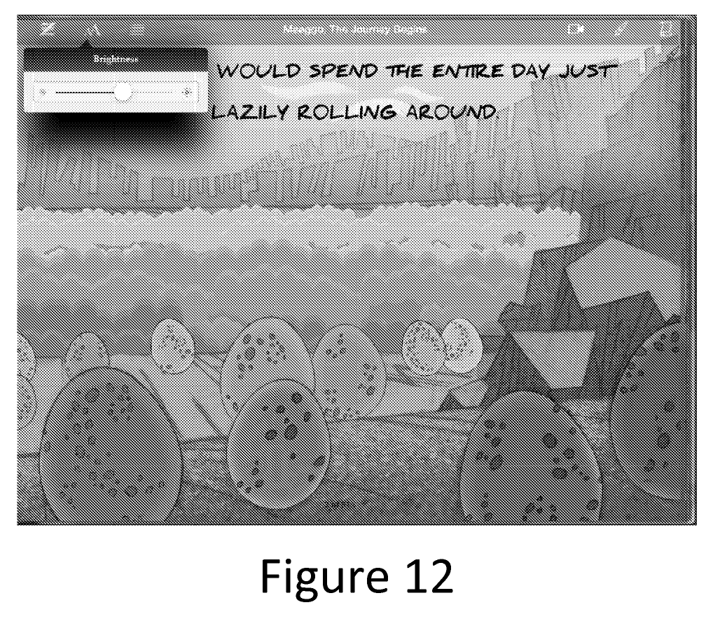

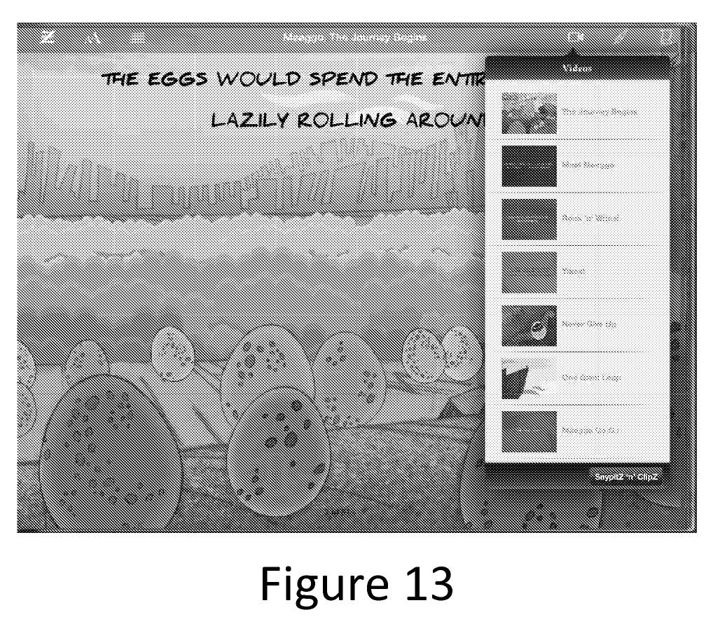

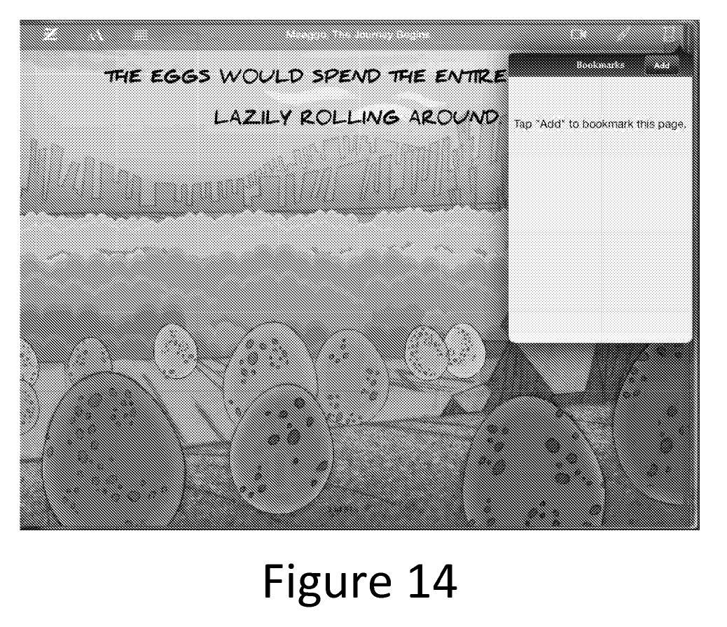

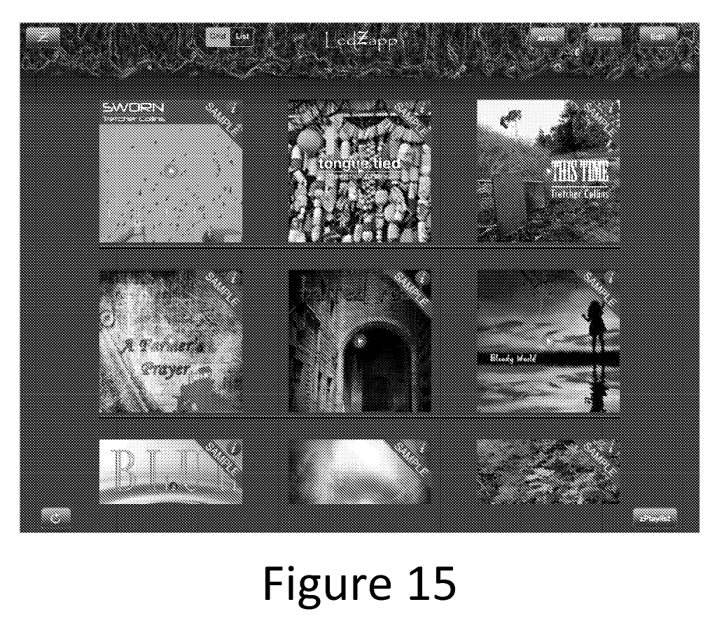

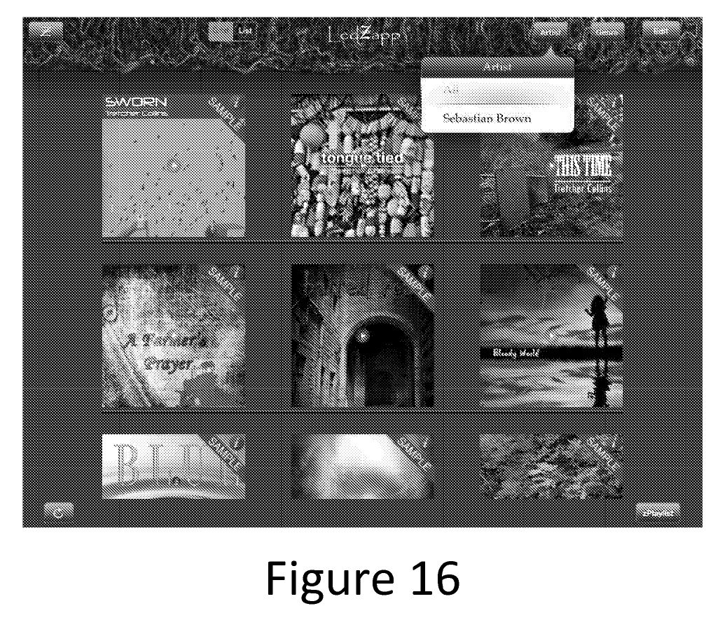

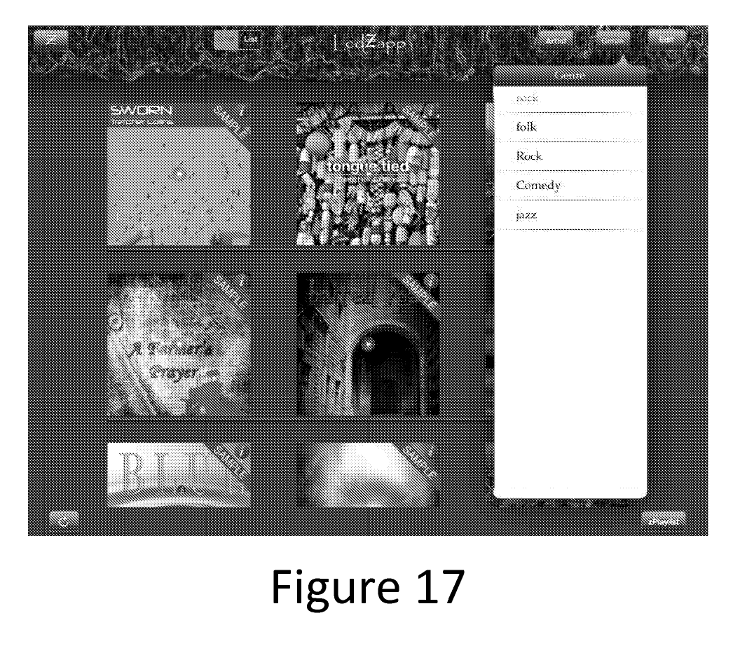

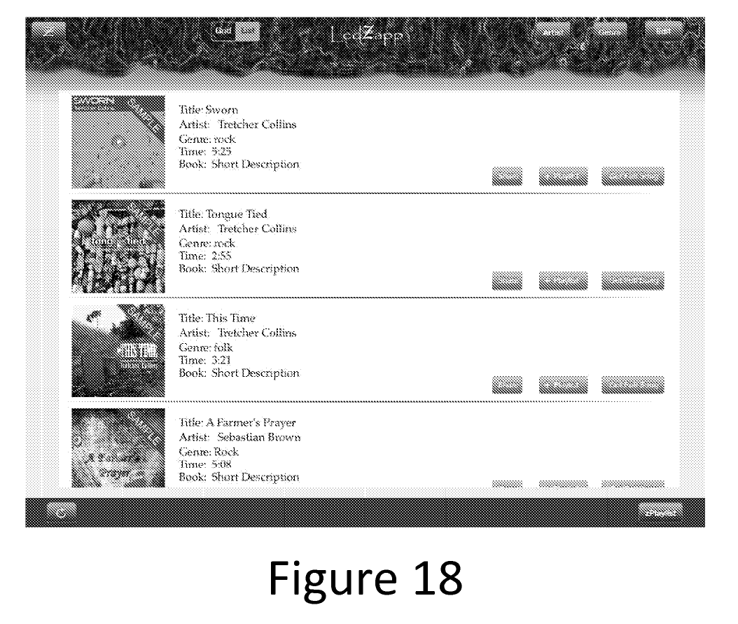

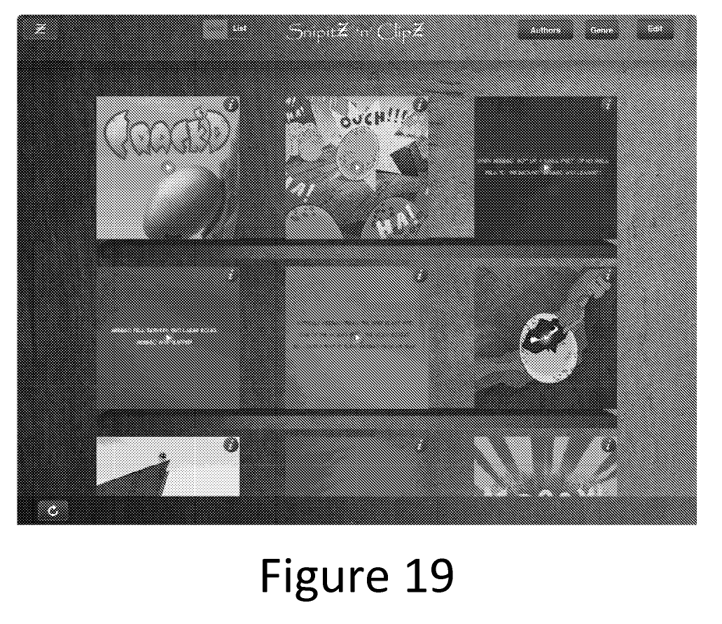

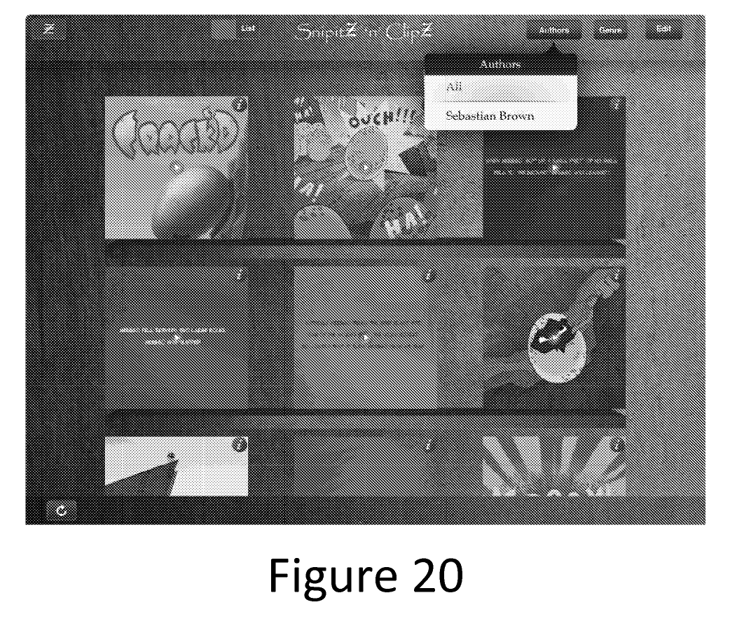

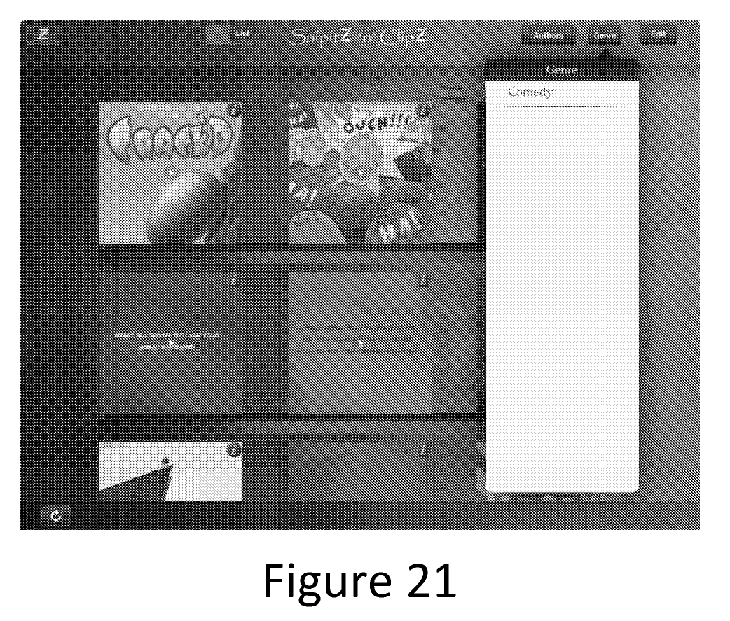

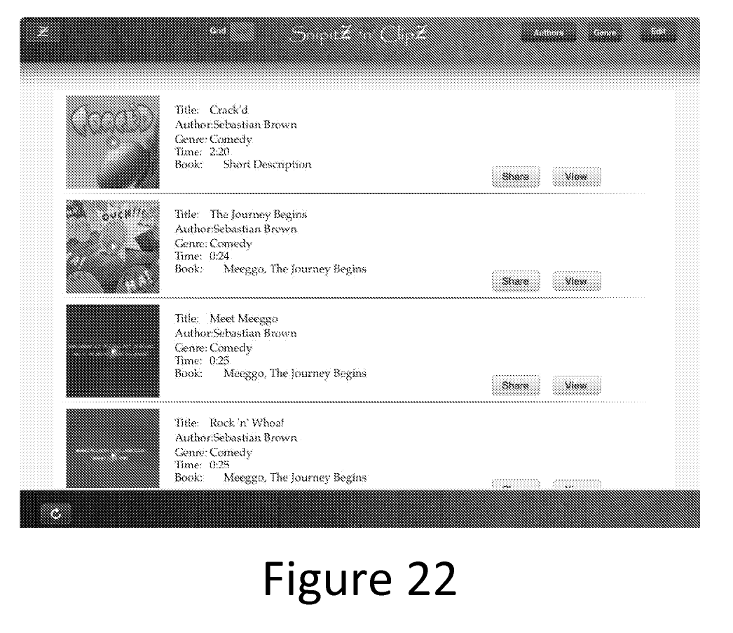

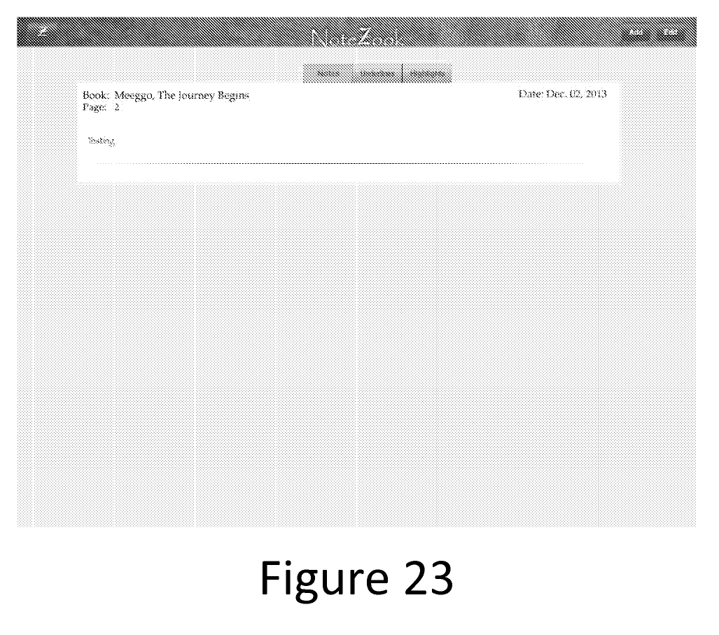

The system, while it may be implemented with a variety of graphical user interfaces, one such graphical user interface is illustrated in FIGS. 6-23.

While illustrative embodiments of the invention have been described, it is noted that various modifications will be apparent to those of ordinary skill in the art in view of the above description and drawings. Such modifications are within the scope of the invention which is limited and defined only by the following claims.

What is claimed:

1. A communications system comprising:
a. a computer device;
b. a communications network;
c. one or more computer-based multimedia applications downloaded from said communications network to said computer device;
d. one or more servers connected to said computer-based multimedia applications through said communications system and computer device;
e. a computer-based multimedia application reader downloaded from said communications network that communicates with one or more of said computer-based multimedia applications and said computer device, said computer-based multimedia application reader capable of copying all multimedia files stored in said computer device and/or said computer-based multimedia applications.
f. a server, connected to said computer-based multimedia application reader through said communications network and/or computer device, said server capable of storing all multimedia files copied by said computer-based multimedia application reader.
